(19) United States
(12) Patent Application Publication
(10) Pub. No.: US 2005/0134087 A1
(43) Pub. Date: Jun. 23, 2005

(54) Auto body or auto body part for a vehicle

(76) Inventors: Thomas Behr, Elchingen (DE); Konrad Eipper, Rottenburg (DE); Wolfgang Fussnegger, Tuebingen (DE); Arndt Gerick, Ulm (DE); Daniel Minnich, Ulm (DE); Matthias Scheffzuek, Tuebingen (DE)

Correspondence Address: PENDORF & CUTLIFF, 5111 MEMORIAL HIGHWAY, TAMPA, FL, 33634-7356, US

(21) Appl. No.: 11/017,350

(22) Filed: Dec. 20, 2004

(30) Foreign Application Priority Data
Dec. 19, 2003 (DE) 10 359 784.0-21

(51) Int. Cl. B62D 25/20

(52) U.S. Cl. 296/187.01

(57) ABSTRACT

The invention pertains to a body part 1 for a vehicle formed at least partly from steel cast parts or light metal cast parts 2, at least one metal part or metal material 3 being introduced to the interior of the body or body part 1 so that the body part 1 after conclusion of the casting process has a closed surface structure, the steel cast parts or light metal cast parts 2 being introduced to the casting mold as reinforcement elements that enter into a fixed bond with the solidified melt on conclusion of the casting process.

### BACKGROUND OF THE INVENTION

1. Field of the Invention

The invention concerns a body or body part for a vehicle formed at least partially from steel cast parts or light metal cast parts, at least one metal part or metal material being incorporated in the interior of the body or body part so that an approximately or substantially closed surface structure is formed.

2. Related Art of the Invention

A method for producing metal or metal foam composite components is already known (DE 101 27 716), in which the flat or shaped metal part is introduced to the cavity of a casting mold. The metal part at least partially limits the cavity. In this production method, a mixture of molten metal and blowing agent is introduced to the cavity and foamed there. For example, U- or L-profiles can be foamed out in cases in which the foamed mold cavity is only partly limited by the inserted metal parts.

A support element for a vehicle body is also known (WO 03/031252) in which the support element consists of cast iron. The support element comprises a cast shell element the outside contour of which forms a cavity. Hollow spheres or a metal foam based on iron are filled into the cavity only after completion of the support element. Because of this, the desired strength is not achieved, since the hollow sphere or metal foam does not enter into a fixed bond with the support element.

### SUMMARY OF THE INVENTION

The underlying task of the invention is to form a thin-walled body or body part for a vehicle so that it meets automotive industry strength and crash requirements.

The task is solved according to the invention in that the steel cast parts or light metal cast parts have metal parts or metal materials that are inserted into the mold before the casting process and are surrounded by the melt and therefore function as reinforcement elements, entering into a firm bond with the solidified melt of the body part.

Since the metal parts or metal materials, hereafter also referred to as reinforcement parts, are introduced to the mold before or during casting, they can enter into a very firm, durable bond with the body structure. Bonding can occur both by bonding proper and also form-fitting engagement. In addition to an increase in strength of the body component, the deformation energy is also substantially increased by the reinforcement part. This is of particular significance with respect to crash requirements. Thin-walled body parts can be produced with the reinforcement parts according to the invention even in areas liable to exposure to a crash.

In a first variant according to the invention it is proposed that the metal parts or metal materials be formed as steel cables or perforated metal parts and/or expanded metal. These metal parts contribute to an increase in strength or fracture energies of the body component without a significant increase in total weight of the body.

Another variant according to a modification of the invention proposes perforated metal parts, metal meshes, metal fabrics or fiber materials.

The metal parts or reinforcement parts formed as reinforcement elements are expediently inserted into the casting dies and fixed before casting occurs and are enclosed by the molten metal.

In another variant steel hollow spheres are proposed as metal parts. In this case the aspect of weight saving at high deformation energy absorption is particularly prominent. The corresponding body parts are preferably used in the front area and door area of vehicles.

For this purpose it is advantageous that the steel hollow spheres are combined into molded elements or form molded parts in the form of light components.

According to another variant of the invention it is finally proposed that the reinforcement parts or light components be enclosed by a metal foam forming the body component.

It is of special significance for the present invention that the casting method for the production of a body or body part consists of the following process steps:

The metal parts are inserted into the mold so that they are enclosed fully by the molten metal being added. At least the metal parts designed as light components are enclosed or surrounded by a metal foil. Penetration of the molten metal into the light component is reduced by this.

The metal parts are fixed in the molds before the molten metal is poured into the casting mold.

### BRIEF DESCRIPTION OF THE DRAWING

Additional advantages and details of the invention are explained in the patent claims and in the description and shown in the Figures:

FIG. 1 shows a first illustrative embodiment of a body part with a cast element, into the interior of which interior steel hollow spheres are introduced as shaped mold component part,

FIG. 2 shows a second illustrative embodiment of a body part with steel cables introduced to the interior,

FIG. 3 shows a third illustrative embodiment of a body part similar to FIG. 2,

FIG. 4 shows a fourth illustrative embodiment of a body part with an inserted wire mesh,

FIG. 5 shows a fifth illustrative embodiment of a body part with an inserted expanded metal.

### DETAILED DESCRIPTION OF THE INVENTION

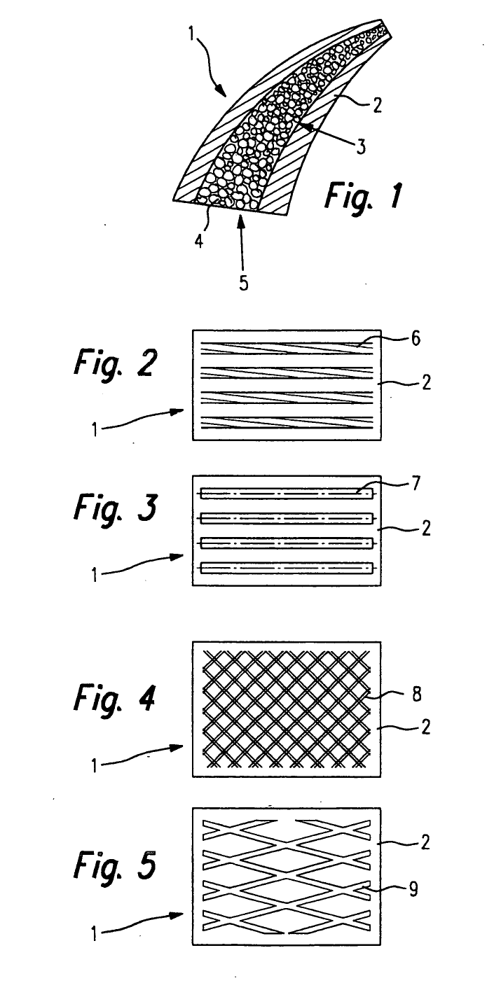

In the drawing, a cast part or cast element is denoted 2, which can be formed from steel or aluminum. Steel hollow spheres 4 according to the illustrative embodiment of FIG. 1, steel cables 6 according to FIG. 2, fluted steel cables 7 according to FIG. 3, wire mesh 8 according to FIG. 4 and an expanded metal or metal fabric 9 according to FIG. 5 are inserted into an internal space 5 of cast part 2.

The cast part 2 is part of a body or body part 1 only partially shown in the drawing. The body or body part 1 can be produced in a casting method or die-casting method according to the following process steps.

The metal parts are first inserted into the mold, the mold is closed and the molten metal is introduced into the mold as a die-casting or permanent mold casting so that the introduced metal parts are completely surrounded in the solidified state and therefore enter into a firm bond with the wall parts of the body 1. In order for the metal parts 3 to retain the desired position in the melt, they are fixed before the melting process and only then is the melt introduced to the casting mold.

In another variant, the metal or material parts 3 formed as light components, especially steel hollow spheres 4, are surrounded with a soluble or meltable enclosure so that they can be dipped and do not fully absorb or optionally can float. The enclosure, for example, can be formed by a metal foil, especially aluminum foil.

This process can be used in steel castings, especially when they do not consist of a high-grade alloy, or in aluminum die castings. Very thin-walled body parts can therefore also be produced that satisfy high crash requirements. This is also achieved in that the outer wall of the body part enters into a fixed bond with the inserted metal parts, since these are completely enclosed by the cast material and the cast material can penetrate into the openings of the wire mesh or expanded material and enter into a fixed mechanical bond with the steel hollow spheres 4 or steel cables 6, 7. The melt can melt the surface of steel cables 6, 7.

1-7. (canceled)

8. A body or body part (1) for a vehicle, formed at least partially from steel cast parts or light metal parts (2), at least one metal part or metal material (3) provided in the interior of the body or body part (1) so that a roughly closed surface structure is formed,
wherein the steel cast parts or light metal parts (2) comprise metal parts or metal materials (3) that are introduced to a mold before the casting process and are surrounded by the melt and thus function as reinforcement parts, establishing a fixed bond with the solidified melt of the body part.

9. The body or body part according to claim 8, wherein the metal parts or metal material (3) are steel cables (6, 7) or perforated metal parts (8) and/or expanded metal (9).

10. The body or body part according to claim 8, wherein the perforated metal parts are formed as metal fabric or fiber materials.

11. The body or body part according to claim 8, wherein the metal parts (3) formed as reinforcement elements are inserted into the mold, fixed and then surrounded by the molten metal.

12. The body or body part according to claim 8, wherein light components formed as steel hollow spheres are bonded as molded elements and/or form molded parts.

13. The body or body part according to claim 8, wherein the steel cast parts or light metal cast parts are formed at least partly from metal foam.

14. A die-casting method for production of a body or body part, comprising:
introducing metal parts (3) into a mold, wherein in the case that metal parts (3) are light components, these are enclosed or surrounded by a foil,
fixing the metal parts (3) in the dies,
introducing molten metal into the casting mold so that the metal parts (3) or foil are fully enclosed by the molten metal and thus function as reinforcement parts, establishing a fixed bond with the solidified melt of the body part, whereby a roughly closed surface structure is formed.
